(19) United States
(12) Patent Application Publication
(10) Pub. No.: US 2021/0300804 A1
(43) Pub. Date: Sep. 30, 2021

(54) WATER CHARACTERISTIC SELECTION SYSTEM AND METHOD

(71) Applicant: PENTAIR PLC, London (GB)

(72) Inventors: Brian BROGA, Elkhorn, WI (US); Justin KUTNEY, Pewaukee, WI (US)

(21) Appl. No.: 17/347,294

(22) Filed: Jun. 14, 2021

Related U.S. Application Data
(63) Continuation of application No. PCT/GB2019/053529, filed on Dec. 12, 2019.
(60) Provisional application No. 62/778,552, filed on Dec. 12, 2018.

(51) Int. Cl. C02F 1/68; A47L 15/00; A47L 15/44; A47L 15/42; A47J 31/40; A47J 31/52; A47J 31/46; A47J 36/32; C02F 1/00; D06F 39/08; D06F 33/37; D06F 33/34; C02F 5/08; C02F 1/76; B01F 15/00; B01F 13/10; F24C 15/00

(52) U.S. Cl. CPC C02F 1/685; C02F 2103/42; A47L 15/0063; A47L 15/449; A47L 15/4217; A47J 31/407; A47J 31/5255; A47J 31/521; A47J 31/461; A47J 36/321; C02F 1/008; A47L 15/4229; D06F 39/088; D06F 33/37; D06F 33/34; C02F 5/08; C02F 1/76; B01F 15/00344; B01F 15/00136; B01F 13/1063; F24C 15/003; A47L 2501/07; A47L 2501/26; A47L 2501/01; A47L 2401/023; A47L 2401/026; A47L 2401/14; A47L 15/0055

(57) ABSTRACT

Systems and methods are described, which relate to the control of additive dispensers to provide defined amounts of one or more additive compounds to water to produce customized water. A given additive dispenser may include multiple inputs and/or outputs. Predefined water profiles may be stored in memory. A given water profile may define the amounts of additives to be delivered by the additive dispensers to achieve desired water characteristics. A controller may determine actual water characteristics of input water based on corresponding sensor data, and may compare the actual water characteristics to desired water characteristics in order to determine the amount of additive or additives that should be delivered to the input water to achieve the desired water characteristics. The additive dispensers may be network-enabled and may include transceivers configured to receive instructions related to production of customized water from a user device.

### CROSS-REFERENCE TO RELATED APPLICATIONS

This application is a continuation of International Application No. PCT/GB2019/053529, filed Dec. 12, 2019, which claims priority to U.S. Provisional Application No. 62/778,552 filed Dec. 12, 2018, which is incorporated by reference in its entirety for all purposes.

### BACKGROUND

Water supplied to a home or business, whether through a well or a municipal water supply, may be used in a variety of applications such as drinking, cooking, showers, baths, toilets, pools, agricultural maintenance, and even heat. Conventional water systems can include devices for treating the input water for particular uses and then delivering treated water to the appropriate points-of-use. For example, a filtration system may remove contaminants from the input water to produce drinking water, and various combinations of pipes, valves, and manifolds can direct the filtered water to a drinking water tap; a water softener system can remove minerals that cause hardness and/or add salt and other chemicals to produce softened water usable at shower heads and in washing machines and dishwashers. The most widely used treatment device is a water heater; input water or treated water may be delivered to the water heater for heating (and, typically, storage), and various faucets, shower heads, and other points of use have hot and cold water supplies that a user can blend to produce water at the desired temperature.

Conventionally, blending two water supplies of different temperature to produce output water at a desired temperature is the only “customization” of the output water that can be done at the point-of-use; the characteristics of the output water are otherwise inflexible, and the user must manually treat the output water for a customized use. For example, a user may pour a glass of water from the drinking water tap, and then add an amount of prepackaged composition to affect the flavor, nutritional content, alkalinity, etc. In another example, the user may draw a bath and then pour an amount of bath salts into the filled bathtub to produce a saline and/or aromatic bath.

### SUMMARY

Systems and methods for selectively customizing the characteristics of water output from a water system at a particular point-of-use are provided. Some embodiments provide a system of network-connected devices including a manifold connected between a feed water source and a point-of-use, such as a faucet. The manifold may further have multiple inputs each receiving a different type of feed water, such as input water, softened water, and filtered water. The manifold may include or be coupled to one or more additive dispensers. Additionally or alternatively, the network-connected devices may include one or more point-of-use additive dispensers in fluid communication with the outlet water at the point of use (e.g., attachable to the output port of a faucet, or attachable inline between a water pipe and a tap). An additive dispenser may include a dispensing device and one or more containers loadable into the dispensing device and containing one of the available additives. In various embodiments, and depending upon the point-of-use, the additives may include flavoring compounds, nutritional supplements, mineral compounds, aromatic compounds, medical or therapeutic compounds, rebalancing chemicals, and combinations thereof

The network-connected devices may further include a controller and a user device or a point-of-use interface device having a software application installed thereon that enables the user to select and/or specify a set of desired water characteristics and cause data signals describing the desired water characteristics to be sent to the manifold/point-of-use additive dispenser. The manifold/point-of-use additive dispenser is controllable via data signals to: receive the desired water characteristics; determine a type and an amount of one or more additives that can be combined with the feed water to produce a customized output water having the desired water characteristics; and, cause the one or more additives to be combined with the feed water at the determined amount as the feed water passes through the manifold/point-of-use dispenser to the outlet port. A manifold that receives multiple types of feed water may further be controllable to select which of the inputs to open based on the desired water characteristics. In some embodiments, the network-connected devices may further include other water treatment subsystems, such as filtration systems and water softener systems, and/or other components such as smart valves; these devices may also receive the desired water characteristics and modify their operational parameters to produce treated water that forms all or part of the feed water to the manifold/point-of-use dispenser. Thus, the user can request the customized output water and the system can produce the customized output water on-demand.

In an example embodiment, a system may include a water system and a communication system. The water system may include a water source, an additive dispenser coupled to the water source, and a smart valve coupled between and in fluid communication with the water source and the additive dispenser. The communication system may include a controller that is in electronic communication with the additive dispenser, the smart valve, and a communication network. The controller may include a processor and a memory device configured to store instructions which, when executed, cause the processor to receive, from a user device connected to the communication network, a request for customized water at a point-of-use, and upon receiving the request, control the additive dispenser and the smart valve to modify water received by the additive dispenser from the water source to produce the customized water at the point-of-use.

In some embodiments, the point-of-use may include a water-using appliance that is selected from the group consisting of a pool, a spa, a water tap, a beverage device, a dishwasher, a washing machine, and a steam oven.

In some embodiments, the additive dispenser may be configured to deliver at least one additive to the water received from the water source to produce the customized water. The at least one additive may be selected from the group consisting of salt, chlorine, an acidic compound, a basic compound, an aromatic compound, a flavoring compound, a mineral compound, dye, nutrients, an anti-scalant compound, plant fertilizer, detergent, and fabric softener.

In some embodiments, the request may identify a custom water profile. The instructions, when executed, may cause the processor to retrieve the custom water profile from a custom water profile data store, and identify, based on the custom water profile, the at least one additive and at least one amount of the at least one additive to be delivered to the water. The additive dispenser may be configured to produce the customized water by delivering the at least one amount of the at least one additive to the water.

In some embodiments, the instructions, when executed, cause the processor to determine that the at least one amount of the at least one additive is not available to the additive dispenser, and cause an error message to be displayed at a user interface associated with the point-of-use, the error message indicating insufficient additive levels are available to complete the request.

In some embodiments, the request may identify a desired water characteristic. The instructions, when executed, may cause the processor to cause the additive dispenser to deliver an amount of the at least one additive to the water to produce the customized water having the desired water characteristic.

In some embodiments, the instructions, when executed, may cause the processor to receive sensor data from at least one sensor in fluid communication with an input of the additive dispenser, determine, based on the sensor data, an actual water characteristic of the water received by the additive dispenser, determine a difference between the actual water characteristic to the desired water characteristic, and determine, based on the difference, the amount of the at least one additive to be added to the water to cause the customized water to have the desired water characteristic.

In an example embodiment, a method may include steps of receiving, by a controller from a user device via an electronic communication network, a request for customized water at a point-of-use, upon receiving the request, controlling, by the controller, an additive dispenser and a smart valve coupled between a water source and the additive dispenser to modify water received by the additive dispenser from the water source to produce the customized water at the point-of-use.

In some embodiments, the point-of-use may include a water-using appliance that is selected from the group consisting of a pool, a spa, a water tap, a beverage device, a dishwasher, a washing machine, and a steam oven.

In some embodiments, the method may further include a step of delivering, with the additive dispenser, at least one additive to the water received from the water source to produce the customized water, the at least one additive being selected from the group consisting of salt, chlorine, an acidic compound, a basic compound, an aromatic compound, a flavoring compound, a mineral compound, dye, nutrients, an anti-scalant compound, plant fertilizer, detergent, and fabric softener.

In some embodiments, the request may identify a custom water profile. The method may include steps of retrieving, by the controller, the custom water profile from a custom water profile data store, and identifying, by the controller based on the custom water profile, the at least one additive and at least one amount of the at least one additive to be delivered to the water, wherein the additive dispenser delivers the at least one amount of the additive to the water to produce the customized water.

In some embodiments, the method may include steps of determining, by the controller, that the at least one amount of the at least one additive is not available to the additive dispenser, and causing, by the controller, an error message to be displayed at a user interface associated with the point-of-use, the error message indicating insufficient additive levels are available to complete the request.

In some embodiments, the request identifies a desired water characteristic. The method may further include a step of delivering, by the additive dispenser, an amount of the at least one additive to the water to produce the customized water having the desired water characteristic.

In some embodiments, the method may further include steps of receiving, by the controller, sensor data from at least one sensor in fluid communication with an input of the additive dispenser, determining, by the controller based on the sensor data, an actual water characteristic of the water received by the additive dispenser, determining, by the controller, a difference between the actual water characteristic to the desired water characteristic, and determining, by the controller based on the difference, the amount of the at least one additive to be added to the water to cause the customized water to have the desired water characteristic.

In an example embodiment, an additive dispenser may include a mixing chamber, a cartridge manifold, a cartridge, and a controller. The mixing chamber may include at least one input port in fluid communication with a water source, and at least one output port in fluid communication with a point-of-use. The cartridge manifold may be in fluid communication with the mixing chamber. The cartridge may be coupled to the cartridge manifold and may contain an additive. The cartridge manifold may be configured to control dispensation of the additive from the cartridge into the mixing chamber. The controller may be communicatively coupled to the cartridge manifold. The controller may include a transceiver, a processor, and a memory device configured to store instructions which, when executed, cause the processor to receive a request for customized water via the transceiver, and control the cartridge manifold to deliver an amount of the additive contained in the cartridge to the mixing chamber to produce the customized water.

In some embodiments, the additive dispenser may include a flow meter disposed at the output of the mixing chamber, communicatively coupled to the controller, and configured to generate flow rate data representing fluid flow rate through the output.

In some embodiments, the instructions when executed, further cause the processor to periodically receive the flow rate data from the flow meter, determine that the fluid flow rate through the output is zero based on the flow rate data, and prevent the cartridge manifold from delivering the additive to the mixing chamber until the flow rate data indicates that fluid is flowing at the output.

In some embodiments, the instructions when executed, further cause the processor to periodically receive the flow rate data from the flow meter, perform a comparison of the flow rate data to a look-up table stored in the memory device, and based on the comparison, determine the amount of the additive to be delivered to the mixing chamber by the cartridge manifold.

In some embodiments, the additive dispenser may include a plurality of cartridges, including the cartridge, coupled to the cartridge manifold. Each cartridge may include a respective additive of a plurality of additives.

In some embodiments, the request may identify a water profile. The instructions when executed, may cause the processor to retrieve the water profile from the memory device, determine, based on the water profile, amounts of the plurality of additives to be delivered to the mixing chamber to produce the customized water, and cause the cartridge manifold to deliver the amounts of the plurality of additives to the mixing chamber to produce the customized water.

Features which are described in the context of separate aspects and/or embodiments of the invention may be used together and/or be interchangeable wherever possible. Similarly, where features are, for brevity, described in the context of a single embodiment, those features may also be provided separately or in any suitable sub-combination. Features described in connection with a system may have corresponding features definable and/or combinable with respect to a method or vice versa, and these embodiments are specifically envisaged.

### DESCRIPTION OF THE DRAWINGS

The invention will be better understood and features, aspects and advantages other than those set forth above will become apparent when consideration is given to the following detailed description. Such detailed description makes reference to the following drawings.

FIG. 1 is a diagram of a computing environment for deploying Internet of Things (IoT) devices in accordance with various embodiments of the invention.

FIG. 2 is a block diagram of an example embodiment of an IoT device.

FIG. 3 is a block diagram of an example embodiment of a system in accordance with embodiments of the invention, including a server and IoT devices.

FIG. 4 is a block diagram of an example embodiment of another computing environment in accordance with some embodiments of the invention.

FIG. 5 is a diagram of an example deployment including embodiments of the invention, illustrating a connected residence.

FIG. 6 is a block diagram of an example embodiment of a communication system and a water system having controllable additive dispensers for producing customized output water.

FIG. 7A is a flowchart of an example method for controlling a water system to deliver customized output water to a point-of-use upon request.

FIG. 7B is a flowchart of an example method for controlling water system components to dispense additives into the input water to produce customized output water having a set of desired water characteristics.

FIG. 8 is a block diagram of an example embodiment of a connected additive dispenser and user interface (UI) device installed at a point-of-use.

FIG. 9 is a block diagram of an example embodiment of a connected manifold having an additive dispenser.

### DETAILED DESCRIPTION

Before any embodiments are described in detail, it is to be understood that the invention is not limited in its application to the details of construction and the arrangement of components set forth in the following description or illustrated in the following drawings, which is limited only by the claims that follow the present disclosure. The invention is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the invention.

Additionally, while the following discussion may describe features associated with specific devices, it is understood that additional devices and or features can be used with the described systems and methods, and that the discussed devices and features are used to provide examples of possible embodiments, without being limited.

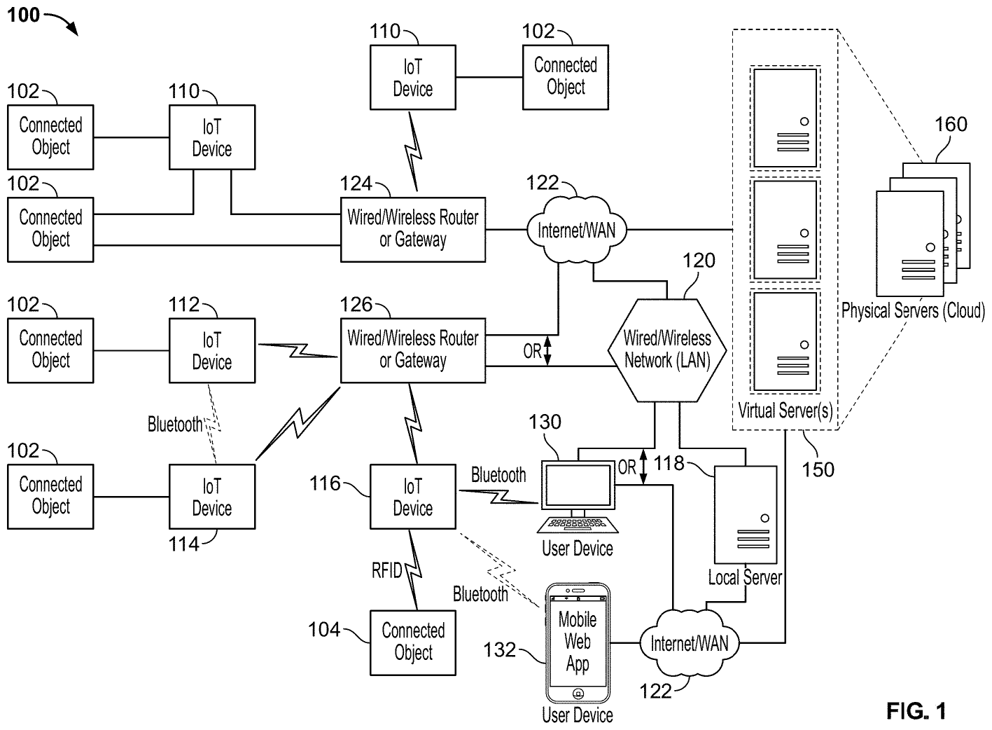

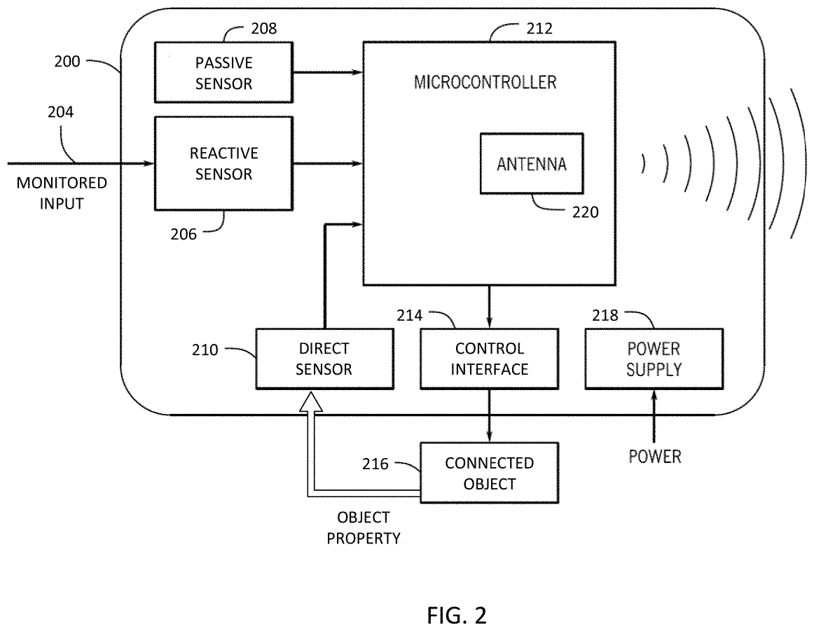

FIG. 1 illustrates an example computing environment 100 for wired and/or wireless monitoring and control of electronic and mechanical devices that are deployed in a physical environment, such as a home or residential environment, a commercial building, a farm or other agricultural facility, industrial environments such as factories and refineries, and any other physical environment where it is feasible and beneficial to deploy so-called “smart” devices, which are natively or retroactively enabled to connect to the internet or another wide-area network (WAN) 122 to send and receive electronic data. In particular, such devices become “connected objects” 102, 104 in the computing environment 100 by interfacing with an internet enabled device, referred to herein as an “Internet-of-Things” (IoT) device, in accordance with various embodiments described herein. Other significant entities, such as a person, an animal (e.g., a farm animal), a pipe or pipeline, a body of water, or the physical environment itself, may become a connected object 102, 104 in the computing environment 100 by interfacing with an IoT device. The interface or connection between a connected object 102, 104 and an IoT device 110, 112, 114, 116 may depend on several factors, non-limiting examples of which include: whether the object is electronic, mechanical, organic, etc.; whether the object is “natively” connected, having the IoT device or another transmitter built-in, or the IoT device is added or connected to the object to make the object “connected;” whether the IoT device connects directly to the connected object, and/or connects to other objects or must be disposed in a particular location (e.g., to deploy a sensor); and, whether the IoT device sends data to the connected object, receives data from the connected object, or both. Example interfaces/connections are described below with respect to FIGS. 1 and 2.

Each of the IoT devices 110-116 may be embedded with electronics, software, sensors, actuators, and network connectivity, either within the device itself or in cooperation with connected servers 118, 160, which enable the IoT devices 110-116 and their embedded software to collect and exchange data. In some embodiments, various IoT devices 110-116 in an environment 100 may send and/or receive data transmissions over a WAN 122, a local area network (LAN) 120, and/or another communication network using any suitable communication protocol. For example, the IoT devices 112-116 may communicate over the LAN 120 with a local server computing device 118, such as in a private network where transmitted data to/from the IoT devices is isolated from the internet or another WAN 122, at least until the data is processed by the local server 118. In some embodiments, (a) local server(s) 118 may be operated at the same location as the IoT devices 112-116, such as at a residence or in an office building. A user device 130 may also be connected to the LAN 120 in order to access the IoT data as described below; alternatively, IP connectivity may be used, connecting the LAN 120 and/or the local server(s) 118 to the Internet or another WAN 122, so that the local and/or remote user devices 130, 132 can access the local server 118.

In still other embodiments, one or more of the IoT devices 110-116 may connect, directly or through a router, gateway, base station, etc. (shown as wired/wireless router or gateway 124, 126), to the WAN 122 in order to communicate with cloud-based computing resources. Such an environment provides a bi-directional, direct-to-cloud communication between the IoT devices 110-116 and one or more application and/or hosting servers. In some embodiments, IoT devices 110-116 may communicate with and directly use the resources of one or more physical, remote server computing devices 160, which may be deployed in one or more data centers (for example) in a particular geographic location or dispersed throughout several geographic locations. In other embodiments, the remote physical servers 160 may cooperate to provide virtualized computing resources that can be allocated for use by, for example, an authorized user of a computing resource service provider. Thus, a user that controls, or provides services for, the IoT devices 110-116 may configure and deploy one or more virtual servers 150 that are allocated the use of certain physical computing resources, such as processor cycles, memory, data storage, etc., of the physical servers 160; the IoT devices 110-116 may, in turn, be configured to connect to the virtual servers 150. For example, an IoT device 110 may be programmed to connect to an IP address associated with an endpoint that connects a virtual network adapter of the servers 150 to a physical network adapter of the physical servers 160. The virtual servers 150, or the computing resource service provider's computing environment in which the virtual servers 150 are deployed, may provide other computing resource services for implementing an IoT platform as described further below.

Given this bi-directional, cloud-based environment, each IoT device 110-116 may be deployed as a direct-to-cloud IoT device. In other words, the deployment of multiple IoT devices 110-116 in a LAN-based or cloud-based environment provides for an internetworking of physical devices, connected devices, and/or smart devices at the network level. Various communication protocols between components may be used, depending on the types of devices connecting to each other and the type, amount, and frequency of data being exchanged. Non-limiting examples of connection protocols include: an IoT device 110, such as a base station or fixture, may have a wired (e.g., CAT5, USB) connection to a router 124 and may use any TCP/IP protocol for wired connections; or, an IoT device 110 may have a wireless connection to a router 124, and may use wireless TCP/IP protocols such as WiFi or MQTT; an IoT device 112 may communicate directly with another IoT device 114 using the above wireless protocols or other suitable protocols such as Bluetooth; IoT device 110-114 connections to a connected object 102 may be wired, or may be indirect based on a sensor interface; or, an IoT device 116 may connect wirelessly to the connected object 104, using a suitable protocol such as RFID for an RFID-enabled connected object 104. More generally, a communication network can include a Wi-Fi network (e.g., an 802.11x network, which can include one or more wireless routers, one or more switches, etc.), a peer-to-peer network (e.g., a Bluetooth network, a ZigBee® network, a Z-Wave® network, a proprietary RF connection, etc.), a cellular network (e.g., a 3G network, a 4G network, a 5G network, etc., complying with any suitable standard, such as CDMA, GSM, LTE, LTE Advanced, WiMAX, etc.), a wired network, an EnOcean® network, etc. In some embodiments, the communication network can be a LAN, a WAN, a public network (e.g., the Internet), a private or semi-private network (e.g., a corporate or university intranet), any other suitable type of network, or any suitable combination of networks. Communications links between the pressure switch 201, the router/modem 124, 126, the cloud based server 150, and/or the internet enabled device 110 can each be any suitable communications link or combination of communications links, such as wired links, fiber optic links, Wi-Fi links, Bluetooth links, cellular links, etc.

A user may operate one or more client computing devices 130, such as a desktop or laptop computer, or a mobile computing device 132 such as a phone or tablet, running client software that enables the device 130, 132 to access an interface to the IoT platform provided by a server 118, 150, 160. Each of these client computing devices 130, 132 may include at least one processor executing specific computer-executable instructions (i.e., the running software) stored in a memory coupled to the client computing device. The user may access and run a client-based software such as a web browser or web application, in order to request access to the system level software and/or the GUI (e.g., by entering a Uniform Resource Locator (URL) for a web page including the GUI). This request may identify the IP address for the server(s), as well as instructions to generate and render the GUI and/or web page for the system level software. The server(s) may execute one or more software instructions to generate and render the GUI, and transmit it to the client computing device 130, 132 for display. The server(s) 118, 150, 160 may include components and data processing capabilities used to host and run software applications that allow for bi-directional communication between each IoT device 110-116 and the server(s). For example, the server(s) may host the customizable software that is deployed to, and installed on, each IoT device 110-116. The server(s) may also run the software and protocols for other services used by the IoT platform, as well as for the interface to the client computing devices 130, 132. Example uses of the user interface to the IoT platform include configuring and deploying server resources, configuring and deploying software and settings for IoT devices, obtaining and/or reviewing data collected by the server(s) from the IoT devices 110-116 (e.g., viewing current status), performing and/or reviewing data analysis, accessing particular IoT devices 110-116, etc.

FIG. 2 shows the internal (i.e., partially or fully inside a housing) components of an example IoT device 200 in accordance with some embodiments of the invention (e.g., as an example of one or more of the IoT devices 110-116 of FIG. 1). As shown in FIG. 2, an IoT device 200 may serve to both collect data associated with a connected object 216, and control one or more operations and/or operating parameters of the connected object 216; in other embodiments, an IoT device for the connected object 216 may only collect and report data, or only control operations/configurations of the connected object 216. To collect data associated with the connected object 216, the IoT device 200 may include, connect to, or communicate with one or more of several different types of sensors. Non-limiting examples of types of sensors that may cooperate with or be incorporated in the IoT device 200 include reactive sensors 206, passive sensors 208, and direct sensors 210, among others. A reactive sensor 206 can detect and report certain monitored inputs 204 on the connected object 216 or the IoT device 200 itself; examples include a pressure transducer that detects a button press or a fluid pressure level, a moisture sensor, a flow rate sensor, a photodiode or other light receptor, and a sample analyzer that collects a sample (e.g., of water in which the sensor 206 is submerged) and measures a property of the sample (e.g., total dissolved solids; note that a sample analyzer may also be a direct sensor 210 if the connected object 216 is a body of water (as opposed to a water filter in the body of water)). A passive sensor 208 can detect environmental and other ambient properties; examples include an ambient temperature sensor, an ambient light sensor (e.g., for sunlight), a humidistat, etc. A direct sensor 210 can be connected to the connected object 216, or in communication therewith, or otherwise oriented to monitor one or more specific properties of the connected object 216; examples include a thermistor for monitoring the temperature of the connected object 216, a biometric sensor, a sample analyzer (e.g., of water at the inlet or outlet of a water filter), a current sensor, a speed sensor, etc.

Any of the sensors 206-210 may be configured to monitor a corresponding property continuously, at intervals, or randomly, and/or may “listen” for inputs and react when they are detected. Sensors 206-210 may also continuously generate data, or may only generate data at intervals, or only when the monitored property meets one or more particular thresholds; the generated data may describe the state of the property being measured. The sensors 206-210 may send the data to a microcontroller 212 of the IoT device 200. A microcontroller 212 may be any suitable microprocessor, including single- and multi-core CPUs, wireless-enabled microcontrollers, and other known microcontrollers having the processing power to receive data from the sensors and transmit the data to a receiving device such as a gateway/router or a local or cloud server. In some embodiments, the microcontroller 212 can be configured to itself act as a wireless gateway module. For example, the microcontroller 212 can be implemented using a single-chip wireless microcontroller, such as the CC3200MOD microcontroller available from Texas Instruments® (of Dallas, Tex.), which can include a CC3200R1M2RGC microcontroller from Texas Instruments®. A microcontroller 212 may further have sufficient computing power to receive control commands from a router/gateway, a server, another IoT device, or a client computing device, and deliver the control commands to the connected object 216 as described below. The microcontroller 212 may further have sufficient resources to store and execute data analysis algorithms, such as processing methods that enable the microcontroller 212 to evaluate sensor 206-210 data and issue control commands to the connected object 216 based on the evaluated data. For example, the microcontroller 212 and/or the IoT device 200 can include any suitable volatile memory, non-volatile memory, storage, or any suitable combination thereof. For example, the memory can include RAM, ROM, EEPROM, one or more flash drives, one or more hard disks, one or more solid state drives, one or more optical drives, etc. In some embodiments, the memory can have encoded thereon a computer program for controlling operation of a hardware processor (e.g., microcontroller 212) in the form of computer executable instructions that, when executed by the hardware processor, cause the hardware processor to perform one or more actions as indicated by the instructions.

In some embodiments, the microcontroller 212 or the IoT device 200 can include one or more antennas 220 configured to send and/or receive wireless signals, such as signals for communicating over Wi-Fi, Bluetooth, ZigBee, Z-Wave, free-space optical, etc. In some such embodiments, the antenna(s) 220 can receive signals from the wireless gateway module, and can transmit the signals to the microcontroller 212 for processing into commands. Additionally or alternatively, the antenna 220 can send signals generated by the microcontroller 212 to the wireless gateway/router. In some embodiments, the antenna(s) 220 can be an integral part of the microcontroller 212. Alternatively, in some embodiments, the antenna 220 can be mounted to a printed circuit board (PCB) and electrically connected to the microcontroller 212, and/or can be mounted to a housing of the IoT device 200. In some embodiments, the IoT device 200 can communicate with server(s) and/or other IoT devices in the network using the antenna(s) 220. For example, the IoT device 200 can use the antenna(s) 220 to communicate using a direct connection (e.g., over a Bluetooth connection, over a direct Wi-Fi connection such as an ad hoc Wi-Fi connection or Direct Wi-Fi connection), and/or an indirect connection (e.g., over a LAN, over a mesh network, etc.).

In some embodiments, the IoT device 200 can include a control interface 214 that enables the IoT device 200 to control operations and/or to change configuration settings or other data of the connected object 216. The control interface 214 may include any suitable electrical and/or electronic components and connections needed to enable the desired control of the connected object 216. For example, a control interface 214 for a water pump can connect to the power supply circuit of the pump and, based on signals from the microcontroller 212, selectively provide power for operation of the pump. In this example, the control interface 214 or the IoT device 200 can be connected to both a source of power (e.g., a household electrical grid) and wires/cable(s) connected to the pump, and can either provide power to the pump or inhibit power from being provided to the pump. The microcontroller 212 may provide the appropriate format of signal to cause the control interface 214 to apply the desired control. For example, in an analog environment such as the pump power control, the control interface 214 may be a series of switches, and the microcontroller 212 may send one or more signals that open or close the switches as needed to apply the desired power setting. In another example, the connected object 216 may be a digital device, and the control interface 214 may be an application programming interface (API) that converts the microcontroller 212 control signals to function calls that the control interface 214 sends to the connected object 216 to change its operating parameters.

In some embodiments, the IoT device 200 can include a power supply 218 that can provide power for operation of the microcontroller 212 and/or any other suitable low voltage devices within the IoT device 200. For example, the IoT device 200 can receive input power at 230 V and 60 Hertz (Hz), which is not suitable for operation of the microcontroller 212, which is typically a low voltage device (e.g., operating at 3.3 V DC, 5 V DC, 12 V DC, 24 V DC, etc.). In some embodiments, power supply 218 can receive AC power (e.g., at 230 V, 60 Hz), convert the AC power to low voltage DC power, and distribute power to one or more other components of the IoT device 200, such as the microcontroller 212. In other embodiments, the power supply 218 may be one or more onboard batteries (e.g., AAA batteries) contained within the housing of the IoT device 200. The power supply 218 may provide power in a variety of other ways, for example, from harvested energy, wirelessly through inductive coupling or resonant inductive coupling, or in any other known way. In some embodiments, the power supply 218 or another energy storage device such as a battery, an ultracapacitor, a fuel cell, etc., can provide supplemental power to continue to operate the IoT device 200 when an external power supply is interrupted or a primary battery fails.

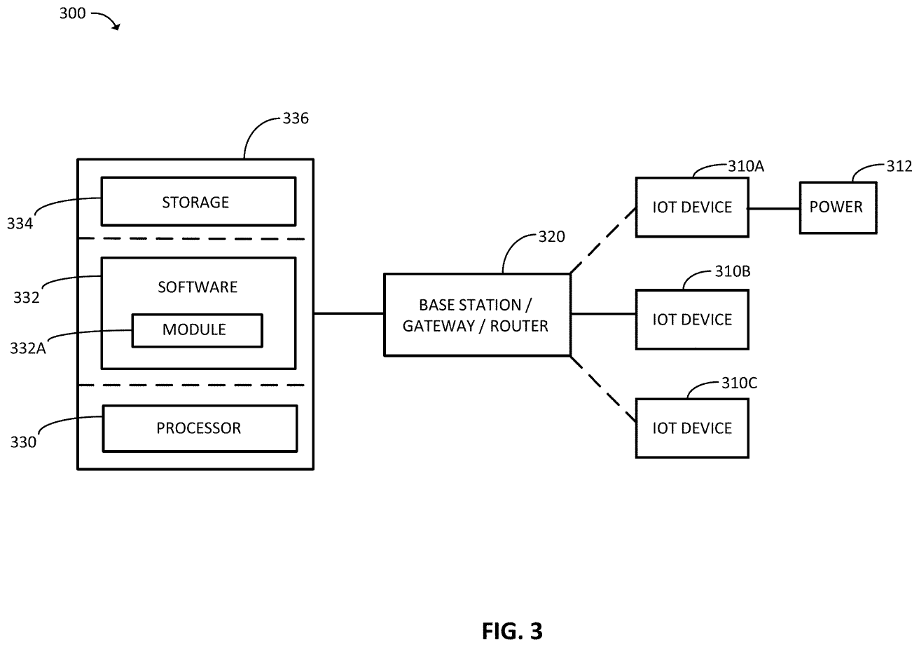

FIG. 3 is a block diagram 300 that illustrates additional details of a communication system. The block diagram 300 includes the IoT devices 310A-C, a power source 312, a base station, router, or gateway 320, a server 336, a processor 330, software 332, and storage 334.

As described above, the IoT devices 310 may sense data about the environment and/or users and/or a connected object; an IoT device 310A-C can provide raw sensor data and/or processed sensor data to server 336 via gateway 320. Additionally, or alternatively, the IoT devices 310 may receive data, such as control signals generated by the server 336 or a client computing device or sensor data from other IoT devices, from the server 336 via the gateway 320. The IoT devices 310 may communicate with the gateway 320 through a wired (e.g., IoT device 310B) or wireless connection. The IoT device 310B may also receive power through its wired connection with the gateway 320; the IoT device 310A receives power from the power source 312; the IoT device 310C does not have a separate power source and may instead rely on piezoelectric technology or other technology to provide sufficient energy for transmitting information to the gateway 320. Depending on the embodiment, the IoT devices 310 may employ a range of technologies. For example, the IoT devices 310 may detect heat or pressure changes, may detect touch, or may detect changes in a variety of health indicators. Certain IoT devices 310 may rely on Bluetooth, iBeacon, or near field communication technology. In some embodiments, the IoT devices 310 may include an accelerometer. The IoT devices 310 may be present in a variety of locations within an organization's environment. The IoT devices 310 may be embedded in an article of furniture, such as a chair or table, and/or may be embedded in or coupled to a wall, partition, ceiling, of floor. The IoT devices 310 may also be associated with a user, present, for example, in a user's identification badge or mobile communication device (e.g., a smartphone, in a wrist worn device, etc.).

The gateway 320 relays information to the server 336 and may be coupled to the server 336 via a LAN or wide area network (WAN). The gateway 320 may be any device suitable to receive, aggregate, and/or relay information from the IoT devices 310A-C, including, for example, a wireless router or a Room Wizard™. The gateway 320 may include existing technology affiliated with other services of an organization or may be provided to an organization specifically for use with the IoT devices 310. For example, the gateway 320 may be provided in the form of a base station comprising computing resources, such as a processor, memory, and specific program instructions (e.g., software or firmware) that the processor executes to communicate with and/or monitor deployed IoT devices 310. In some embodiments, more than one gateway 320 may be used to optimize performance. For example, the number and/or positioning of gateways may depend on the number and/or positioning of IoT devices 310.

As information from one or more IoT devices 310 reaches the server 336, software 332 may determine how the information is processed. In this embodiment, a software module 332A can configure a commands processor 330 to perform a variety of tasks, such as processing collected data from the IoT devices 310 and/or sending control signals to the IoT devices 310 for controlling the corresponding connected object(s). For example, processor 330 may analyze incoming data related to a user's location, orientation, or interaction with a client computing device. The processor 330 may make determinations or conclusions about a user or group of users, or an object or group of objects, or other environmental or input conditions, based on incoming data. The processor 330 may also relay information or send conclusions to a user or group of users. Incoming data from IoT devices 310, other incoming data or inputs, conclusions, and other data may be stored in storage 334.

In various embodiments, the server 336 may be a virtual server or may represent a cluster of servers. Some or all portions of the block diagram may be located physically on site at an organization's location and some or all may be stored remotely in the cloud. For example, in one embodiment, server 336 may physically include the processor 330 while the software 332, the software module 332A, and the storage 334 are located in a remote or cloud server. In another embodiment, only the software 332 or the storage 334 may be located in a remote or cloud server. The software module 332A may additionally communicate with a variety of other servers, processors, hardware, and software located in the server 336 or in other servers or other locations. For example, the software module 332A may communicate with a second server to ensure that a user's calendar or reservation information is up-to-date.

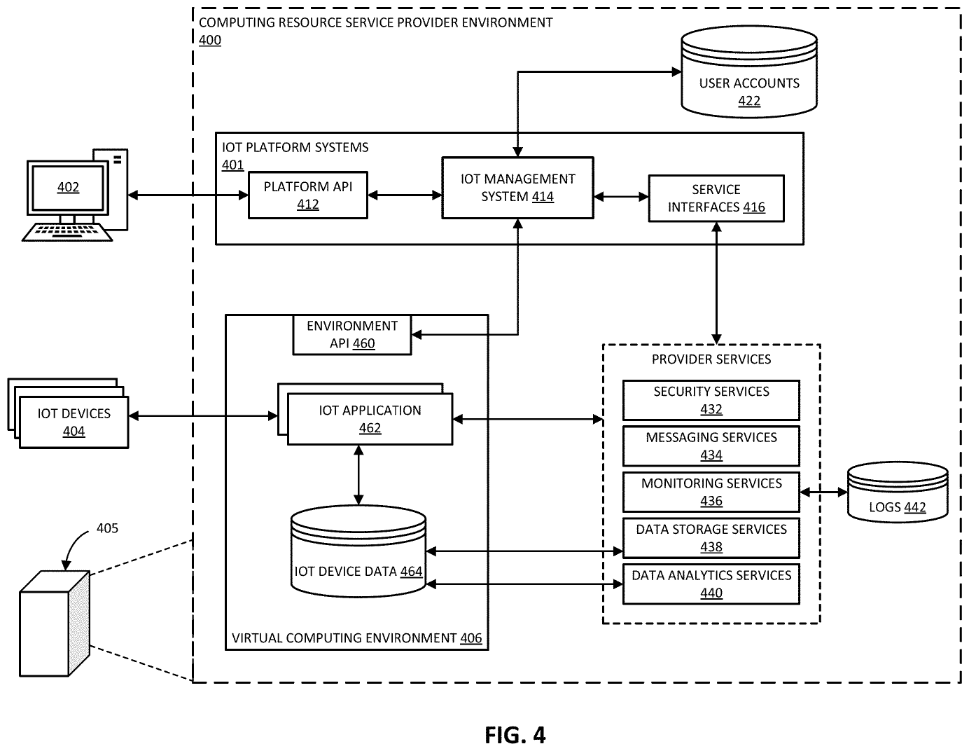

Referring to FIG. 4, embodiments of the invention may operate within or upon computing systems (e.g., the hardware computing device 405) of a computing resource service provider that provide a computing environment 400 accessible, via one or more computer networks, by users of user computing devices 402 and by one or more IoT devices 404 configured and deployed as described above. The computing environment 400 may, for example, be provided by the virtual servers 150 and/or the physical servers 160 of FIG. 1 (i.e., computing device 405 may be one of the physical servers 160 of FIG. 1). That is, where FIG. 1 illustrates the conceptual operation of the present systems and methods in interaction, via the computing devices 130, 132, with a “client,” or administrator of the IoT devices 110-116 deployed in a computing environment 100, FIG. 4 illustrates a computing architecture in which a client may access the computing systems of the computing resource service provider environment 400 (e.g., using the client's user account credentials) using a computing device 402 to connect to one or more user interfaces provided (e.g., as websites, web applications, command consoles, APIs, etc.) in the environment 400. The user interfaces may enable the client to manage virtual computing resources allocated to the client's account and configured to implement an IoT platform for the client's IoT devices 404.

The computing resource service provider environment 400 may include one or more systems 401 that cooperate to enable deployment of the IoT platform using a customized configuration for a particular user. The systems 401 may include a platform API 412 to which the client, via computing device 402, connects in order to configure, deploy, manage, and otherwise interact with the client's IoT platform. In some embodiments, the platform API 412 provides secure access to an IoT management system 414 that includes or accesses services and data needed to interact with an IoT platform, an IoT application 462, and/or IoT devices 404 that are deployed within or connect to the client's virtual computing environment 406, described below. In some embodiments, the IoT management system 414 may access one or more user account data stores 422 that contain user account information and other private information associated with the client's user account. For example, the IoT management system 414 may store and retrieve configuration settings for particular IoT devices 404 and/or IoT applications 462 that the client has previously submitted.

The computing resource service provider implements, within its computing environment 400, at least one virtual computing environment 406 in which users may obtain virtual computing resources that enable the users to run programs, store, retrieve, and process data, access services of the computing resource service provider environment 400, etc. The virtual computing environment 406 may be one of any suitable type and/or configuration of a compute resource virtualization platform implemented on one or more physical computing devices. Non-limiting examples of virtual computing environments 406 include data centers, clusters of data centers organized into zones or regions, a public or private cloud environment, etc. The virtual computing environment 406 may be associated with and controlled and managed by the client. In some embodiments, the virtual computing environment 406 of a particular client may be dedicated to the client, and access thereto by any other user or service of the computing resource service provider environment 400 prohibited except in accordance with access permissions granted by the client. In some embodiments, an environment API 460 may serve as a front-end interface that provides access to the resources of the virtual computing environment 406 based on whether or not requests to access the environment 406 are authorized. For example, the IoT management system 414 may deploy IoT platform-related resources, push configuration changes, and request information about such resources via calls to the environment API 460. Additionally or alternatively, other channels, such as TLS-encrypted data channels, may be enabled to allow data to enter or exit the environment 406 without passing through the environment API 460. For example, an IoT application 462 in the environment 406 may be configured to communicate directly with IoT devices 404 and/or certain services in the computing resource service provider environment 400.

In some embodiments, a client's IoT platform may be deployed by installing one or more IoT applications 462 into the client's virtual computing environment 406. An IoT application 462 may be a software program or suite of software programs including program instructions that enable a processor executing the IoT application 462 to communicate with deployed IoT devices 404, sending and/or receiving data, processing data, and making decisions in accordance with the desired goals and functions of the IoT platform. For example, the IoT application 462 may cause the processor to receive sensor data from the IoT devices 404, process the data to determine whether to take any actions, and then perform any identified action such as reporting the status of connected objects to the client, sending new commands to one or more of the IoT devices 404, storing data (e.g., in an IoT device data store 464), etc. The IoT application may be executed within virtual computing resources allocated to the client's virtual computing environment 406, such as one or more virtual machine instances or logical container instances configured to provide virtualized physical computing resources for the purpose of performing the IoT application's functions. For example, a virtual machine instance may be launched from a software image including the configuration information (e.g., operating system, memory, disk storage, network interface configuration, and software program code) needed to provide an execution environment for the IoT application 462.

The computing resource service provider environment 400 may include data processing architecture that implements systems and services that operate “outside” of any particular user's virtual computing environment and perform various functions, such as managing communications to the virtual computing environments, providing electronic data storage, and performing security assessments and other data analysis functions. These systems and services may communicate with each other, with devices and services outside of the computing resource service provider environment 400, and/or with the virtual computing environments. Services depicted in the figures as inside a particular virtual computing environment 406 or outside all virtual computing environments may be suitably modified to operate in the data processing architecture in a different fashion than what is depicted. The IoT management system 414 may include or communicate with one or more service interfaces 416, such as APIs, that enable the IoT management system 414 and/or other components of a deployed IoT platform (e.g., an IoT application 462) to interact with one or more of these systems and services. Non-limiting examples of provider services that may be invoked or accessed to work in conjunction with the IoT platform include: security services 432 that maintain and apply security policies, access controls, and the like, encrypt and decrypt information, create secure transmission (e.g., TLS) channels, etc.; messaging services 434 that transmit triggering events and other notifications between subscribing users and services, and or/ provide queueing services for prioritizing synchronous and asynchronous operations (e.g., API calls); monitoring services 436 that monitor network activity and computing resource usage and generate logs 442 of activity; data storage services 438 that maintain distributed storage devices, databases, etc., and that may maintain and/or obtain data stored in an IoT device data store 464; and, data analytics services 440 that may collect data (e.g., aggregated sensor data) and perform analytics on the data, such as machine learning, trend analysis, general monitoring/alerting, etc.

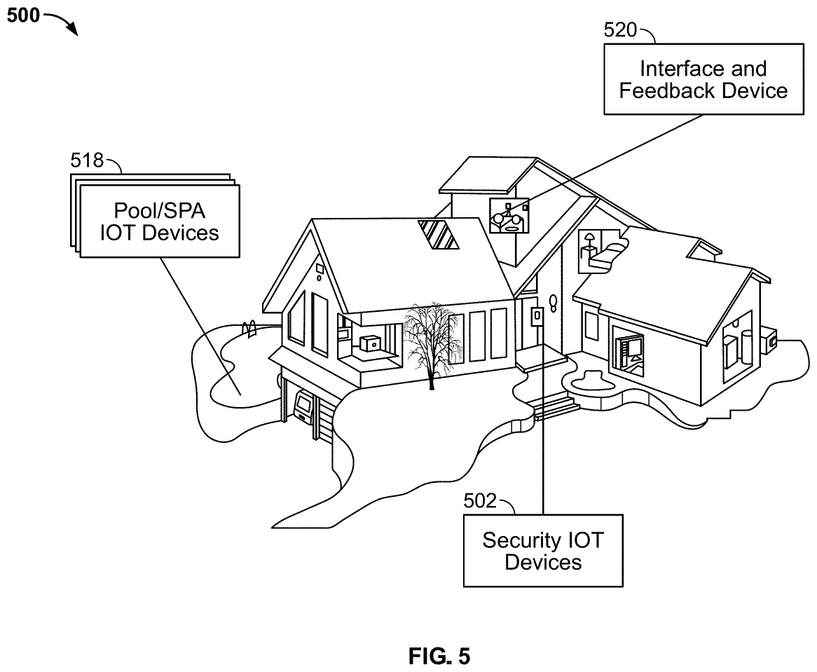

FIG. 5 is a diagram 500 of an example IoT device deployment at a residence in order to create a set of connected objects around the home. The illustrated example IoT devices for connecting to certain objects are not limiting, but are demonstrative of a “smart home” concept where the status can be monitored, and/or operations controlled, for residential devices and systems that historically could only be monitored and controlled manually. Additionally, using the IoT platform described above, together with user interactions and feedback, data from different types of objects and IoT devices may be collected, aggregated, and analyzed to identify previously unknown optimizations, synergies, impacts, and cooperative functionalities between objects in the home. In the illustrated example, the IoT devices may be natively included as a component of the corresponding connected object, or may be retroactively connected (e.g., via sensors and control interfaces as described above) to an unconnected object to connect that object to the IoT platform.

Non-limiting example IoT devices in the diagram 500 include: security IoT devices 502 that monitor home activity, such as smart doorbells, indoor and outdoor video cameras, security/alarm systems, etc.; fixture IoT devices 504 for connecting to “analog” home fixtures, such as faucets and other plumbing; appliance IoT devices 506 for connecting to in-home appliances such as televisions, washers and dryers, refrigerators, dishwashers, garbage disposals, coffee makers, etc.; HVAC IoT devices 508 for connecting to air conditioning units, heating units, vents, etc.; water supply IoT devices 510 for connecting to water heaters, water softeners, water filtration systems, water and sewer pipes, sump pumps and other water pumps, etc.; interior environmental sensor devices 512 such as motion detectors, light detectors, sound detectors, smoke detectors, carbon monoxide detectors, thermostats, etc.; exterior sensor devices 514 such as light and motion detectors, rain sensors, wind sensors, etc.; irrigation IoT devices 516 for connecting to watering system control panels, valves, water lines, areas of earth/soil, etc.; and, pool and spa IoT devices 518 for connecting to pool controls, pool pumps, pool lights, the pool/spa itself, etc. Some or all of the IoT devices 502-518 may collect and send data to a gateway, router, or base station in the home, or directly to a cloud-based server; configuration and control commands may be transmitted in the opposite direction.

The deployment may further include one or more IoT platform interface/feedback devices 520, such as a resident's desktop PC or smartphone having software or a browser interface executing thereon to access the IoT platform and monitor, configure, control, add, remove, change, and perform other management operations on the IoT devices 502-518 and/or interact with collected and analyzed data. The IoT platform may further include a vehicle IoT system 530 installed in the resident's vehicle. In some embodiments, the installation may include a user interface similar to that of the feedback device 520, installed on a computer of the vehicle and presented, e.g., on a navigation screen or another display device. Additionally or alternatively, the vehicle IoT system 530 may include one or more IoT devices that monitor and/or control various properties of the vehicle, such as motor speed and temperature, fuel/battery level, interior temperature, ignition, etc.

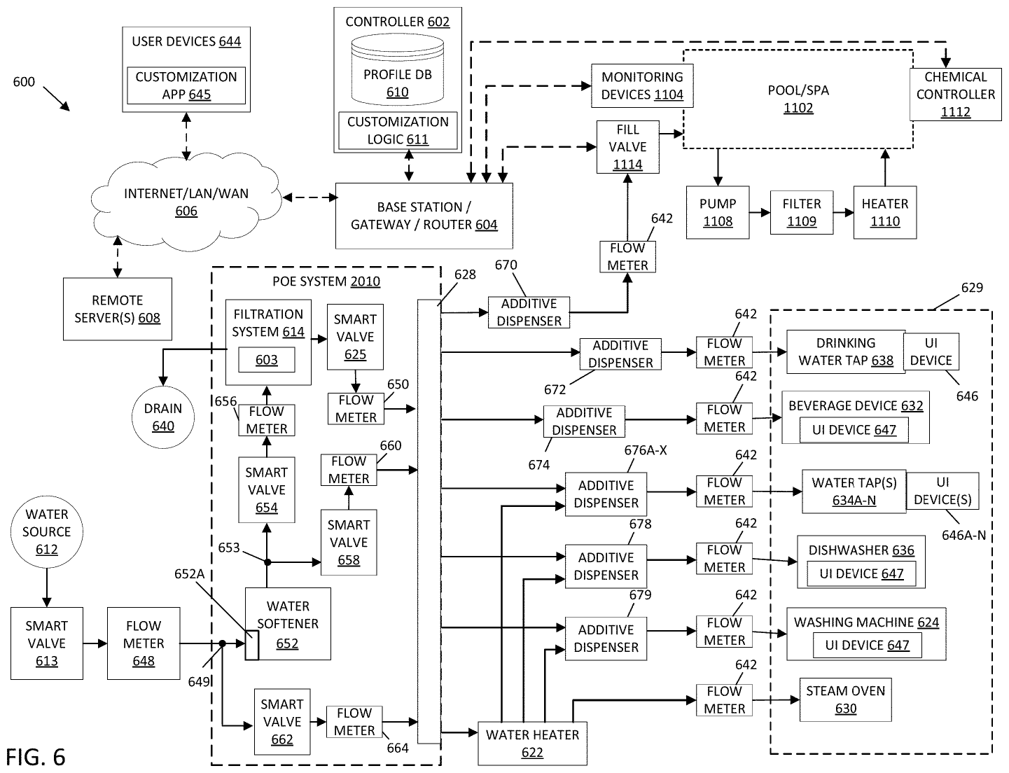

FIG. 6 shows an illustrative system 600 that enables the monitoring, performance evaluation, and control of connected devices in a residential water system. The system 600 may include one or more network-enabled devices (e.g., which may each include or correspond to an IoT device such as the IoT device 200 of FIG. 2) including without limitation: a controller 602; smart valves (e.g., valves 613, 625, 654, 658, and 662); flow meters (e.g., meters 642, 648, 650, 656, 660, and 664); manifolds 628; pumps 1108; filters 1109; monitoring devices 1104 and sensors; integrated systems such as a water filtration system 614, a water softener system 652, and water heaters 622, 1110; water-using appliances 629; and other water system components that can be network-enabled as described herein. For example, in some embodiments the system 600 may include any network-enabled component of the water system and any of its subsystems, such as water subsystems dedicated to management of water at a residential feature (e.g., a pool/spa 1102), or within an area of the residence or building (e.g., in a basement or in a kitchen), or at a particular point in the flow of water through the water system. For example, the system 600 can include a point-of-entry (POE) system 2010 (and any integrated systems and/or components thereof) at a point-of-entry where feed water (i.e., from a municipal source, well, or other water source 612) enters the residential water system.

The system 600 may further include one or more remote servers 608, one or more user devices 644, a gateway 604 (e.g., gateway 320 of FIG. 3), which may be alternatively referred to as a base station or a router, and a network 606, which may be a LAN, WAN, or the internet. The gateway 604 may route data (e.g., including commands, messages, sensor data, profile data, alerts, or other applicable information) locally between the network-enabled devices of the system 600 that are in direct communication with the gateway 604, and globally between local devices and remote devices via the network 606. One or more user devices 644 and one or more remote servers 608 may be communicatively coupled to the gateway 604 via the network 606. The user devices 644 may include personal computers, tablets, smart phones, etc. The controller 602 may be in direct communication with the gateway 604 in order to access data at the gateway 604, send commands to the various network-enabled devices (or a specific one or more of the devices), exchange communications with remote servers 608 and/or user devices 644, etc. Alternatively, the controller 602 may communicate directly with some or all of the network-enabled devices. Non-limiting example interactions and processing functions of the controller 602 are described further below.

A smart valve 613 and a flow meter 648 may be coupled between a node 649 and the output of a water source 612, which may be, for example, the main water line into a building such as a residence or business, an output of a water softener, or an output of a hot water heater. For example, the smart valve 613 can be, or can connect to, a municipal water meter with an integrated controller. The smart valve may selectively enable and disable the flow of water into the system 600. The flow meter 648 may measure the flow rate of water passing through it and may generate corresponding flow rate data. The flow meter 648 may be communicatively coupled to the gateway 604 and may thereby transmit flow rate data to the controller 602 or remote servers 608. The smart valve 613 may be communicatively coupled to the gateway 604 and may receive commands from the controller 602, which set the state (e.g., open or closed) of the smart valve 613. The node 649 may split the flow of water output from the flow meter 648 (e.g., with a pipe fitting that splits the flow of water) between an input of the water softener system 652 and an input of a manifold 628. A smart valve 662 and a flow meter 664 may be coupled between the node 649 and an input of the manifold 628, and may operate similarly to the smart valve 613 and the flow meter 648, respectively, to monitor and control the flow of input water into the manifold 628.

The water softener system 652 may be coupled to receive water from one of the two outputs of the node 649. The water softener system 652 may, for example, be an ion exchange system (e.g., a sodium ion exchange system) that reduces the mineral content (e.g., the calcium and magnesium content) of water passing through it to produce “softened” water. In some embodiments, the water softener system 652 may include an internal flow meter and smart valve 652A at its input and/or output, so that the flow of water through the water softener system 652 may be measured and controlled. The input valve 652A of the water softener 652 may be selectively opened and closed by the controller 602 and/or an integrated controller of the water softener 652. In this way, the flow of softened water into the building may be selectively blocked (e.g., when a leak is detected by the water leak sensor 620 or any other applicable leak detection mechanism). The controller 602 may communicate with the water softener 652 or a processor thereof to control the amount of water softening agent (e.g., salt) that the water softener applies to the water it receives from the flow meter 648. In some embodiments, the water softener 652 may be controlled via commands issued (e.g., by controller 602) in connection with providing customized output water at a point-of-use. For example, when a highly saline output water is requested (e.g., at a bathtub faucet), the water softener 652 may receive and process commands that cause it to increase the salt concentration in an output of the “clean” side of the water softener 652 for a period of time.

The output of the water softener system 652 may be coupled to a node 653, which may split the flow of softened water output by the water softener system 652 between an input of the water filtration system 614 and an input of the manifold 628. A smart valve 654 and a flow meter 656 may be coupled between the node 653 and the input of the water filtration system 614, and may operate similarly to the smart valve 613 and the flow meter 648, respectively, to monitor and control the flow of softened water into the filtration system 614. A smart valve 658 and a flow meter 660 may be coupled between the node 653 and an input of the manifold 628, and may operate similarly to the smart valve 613 and the flow meter 648, respectively, to monitor and control the flow of softened water into the manifold 628. In an alternate embodiment, the smart valve 613 may be omitted and the output of the flow meter 648 may be coupled only to the water softener 652, such that the water softener 652 is the only source of water provided to the manifold 628. In this alternate embodiment, the flow of water into the building may be shut off by closing an input valve 652A of the water softener 652 in response to the detection of a leak.

The water filtration system 614 includes water-filtering components working in concert to receive softened or unsoftened water and produce filtered water for drinking and other applications. In some embodiments, the water filtration system 614 uses a combination of reverse osmosis (RO) water filtration and activated carbon water filtration. However, it should be understood that other types of water filtration may be used in combination with or instead of these filtration methods. In such alternate embodiments, the water filtration system 614 may perform ionization, ultraviolet filtration, or infrared filtration. Non-limiting example water-filtering components include a pre-filter, controllable relays (i.e., pipes between different components, having controllable valves), a carbon filter, a membrane, a post filter, and a storage tank. Other embodiments of a water filtration system 614 may include additional or substitute components; for example, controllable relays are typically interconnecting pipes with valves, but may instead be fluid connectors, or a fluid manifold system, or a piston and valve system. An input of the water filtration system 614 (e.g., into the pre-filter; into the relays) may receive water from an output of the flow meter 656. While shown here to be external to the water filtration system 614, in alternate embodiments the smart valve 654 and/or the flow meter 656 may be internal components of the water filtration system 614.

In some embodiments, the water filtration system 614 may include an integrated or otherwise dedicated controller 603, and one or more of the water filtration system 614 components (including the smart valve 654 and/or the flow meter 656, in some embodiments) may be an IoT-enabled or otherwise connected device that communicates with and may be controlled by the controller 603. For example, the controller 603 may receive commands issued by controller 602 or another device in connection with providing customized output water at a point-of-use.

A portion of the input water, referred to herein as permeate or filtered water, may pass through the filtration system 614 for distribution, leaving behind most (e.g., 95%-99%) of the solids originally contained within the input water (e.g., salt or other minerals) referred to herein as concentrate. The concentrate may be routed to a drain 640 via a concentrate outlet of the membrane. The permeate may be passed to an input of a manifold 628 for subsequent use in various water appliances 629, or may be stored in a storage tank for future on-demand use. The storage tank may also be a connected device; for example, the storage tank may include a water level sensor that detects when the storage tank is full. In response, the water level sensor may send data to the controller 603 indicating that the storage tank is full. The controller 603 may then control the relays to stop the flow of water through the water filtration system 614 until the water level sensor detects that the storage tank is no longer full. Alternatively, the controller 603 may send data to the controller 602 indicating that the storage tank is full and, in response, the controller 602 may close a selected one of the smart valves 613, 652A, 654 in order to block the flow of water into the water filtration system 614.

A smart valve 625 may be coupled between the water filtration system 614 and the manifold 628 so that the flow of water into the manifold 628 from the water filtration system 614 may be selectively enabled and disabled. In some embodiments, a flow meter 650 may be coupled between the smart valve 625 and the manifold 628 and may measure the flow rate of water passing between the two components. The flow meter 650 may be communicatively coupled to the gateway 604 and may thereby transmit flow rate data to the controller 602 or remote servers 608. The smart valve 625 may be communicatively coupled to the gateway 604 and may receive commands from the controller 602, which sets the state (e.g., open or closed) of the smart valve 625. These commands may be automatically generated or may be generated in response to user input provided to the controller 602 from the user devices 644 and/or UI devices 646, 647 via the network 606 and the gateway 604. While shown here to be external to the water filtration system 614, in alternate embodiments the smart valve 625 may be an internal component of the water filtration system 614 and may be controlled by the controller 603.

A manifold 628 may be a network-enabled smart manifold, having controllable valves at each of its inputs and outputs so that the flow of water through the manifold 628 may be selectively controlled. For example, any selected output of the manifold 628 may be supplied with a selected water type—unsoftened and unfiltered “feed water” output from the flow meter 664, softened and unfiltered output from the flow meter 660, or softened and filtered output from the flow meter 650. In other embodiments, the system 600 may include multiple manifolds 628, each connecting certain types of water to certain endpoints. For example, the POE system 2010 may include a discrete manifold 628 for distributing each of the feed water, the softened water, and the filtered water; additionally or alternatively, the POE system 2010 may include a first manifold 628 connecting to the water appliances 629, and a second manifold 628 connecting to the first manifold 628, a water heater, and a fill valve 1114 of the pool/spa 1102. A network-enabled controller (e.g., IoT device 200 of FIG. 2) may be included in or coupled to the manifold 628, enabling remote and automatic control of the manifold 628 via a wired or wireless connection to the base station/gateway/router 604. In some embodiments, when the system 600 includes multiple manifolds 628, each manifold 628 may be its own separately-addressable device, having a dedicated controller communicating with the gateway 604 or with a routing-capable controller maintaining its own network address table (NAT) for the manifolds 628.

Water-using appliances 629 in the system 600 may, for example, include a steam oven 630, a beverage device 632, one or more water taps 634A,B, . . . ,N (e.g., leading to the N faucets inside and outside of the building), one or more separate drinking water taps 638, a dishwasher 636 and/or other applicable appliances, such as a washing machine 624. Network-enabled flow meters 642 may be interposed between the manifold 628 and the water appliances 629. Each of the flow meters 642 may include or may be coupled to a network-enabled controller (e.g., IoT device 200 of FIG. 2) by which the flow meters 642 may be communicatively coupled to the gateway 604. The flow meters 642 may monitor the flow rates of water passing between each of the outputs of the manifold 628 and the water appliances 629, and may communicate corresponding flow rate data to the controller 602 through the gateway 604. Each sampling of flow rate data from the flow meters 642, 648, 650, 656, 660, and 664 may be referred to herein as a “data capture” or “flow rate data capture”. From this flow rate data, the controller 602 may identify potential leaks or misuse of filtered water, and may assess the total water consumption and/or the consumption of softened or filtered water as compared to other equivalent homes or businesses in the same area, as will be explained below.

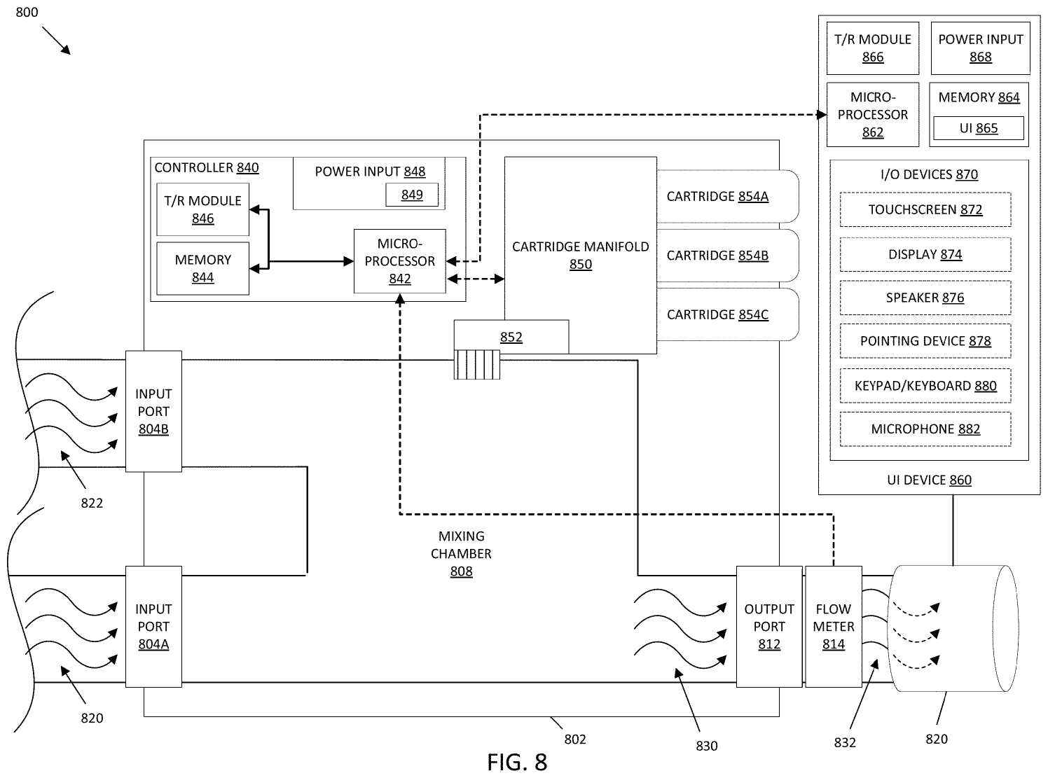

In some embodiments, at least a portion of water-using appliances 629 in the system 600 may be network-enabled devices that are communicatively coupled to the gateway 604 using integrated computing and networking hardware, such as microprocessors, wireless network cards, etc. Such network-enabled appliances may have computing hardware and software configured to provide a built-in user interface (UI) device 647 that enables a user to select customized water settings and activate the water customization functions of the invention described herein. For example, a network-enabled refrigerator may include a UI device 647 with a touchscreen that is integrated into the refrigerator door and displays graphical Uls that present information (e.g., compartment temperature, water filter status) and enable users to control refrigerator operations (e.g., toggle between water and ice dispensers, change the temperature, etc.). Additionally or alternatively, water-using appliances 629 that are not inherently network-enabled, such as faucets and other water taps 634A-N, 638, can be rendered network-enabled by installing an IoT device thereon, as described herein (e.g., IoT device 200 of FIG. 2). Such IoT devices may include or provide a UI device 646 that, like the integrated UI devices 647 of other appliances, enables the user to use the water customization functions at any point-of-use in the water system; in some embodiments, the UI device 646 can be retrofit to existing water devices and fixtures, such as faucets, shower heads, drinking water taps, coffee machines, etc. UI devices 646, 647 may include any suitable hardware computing resources, such as a CPU, microprocessors, input/output devices, memory, data storage volumes, networking devices, etc.; an example UI device 646 is described in detail below with respect to FIG. 8.

The system 600 for producing customized output water at a point-of-use can include one or more additive dispensers, shown in various embodiments in FIG. 6, for dispensing one or more additives into one or more streams of input water in order to impart a desired water characteristic on the input water; in all, the additives dispensed by an additive dispenser can in combination transform the input water stream(s) into customized output water having the desired water characteristics specified by a requesting user, as described further below. In some embodiments, all of the additive dispensers in the system 600 may be the same type of dispenser; alternatively, such as in the illustrated example, the system 600 may include multiple types/embodiments of an additive dispenser, according to the requirements for receiving input water and/or for treating the input water with certain additives. Non-limiting examples include: an additive dispenser 670 receiving input water and delivering it to a swimming pool or spa via a fill valve 1114, and dispensing suitable pool-related additives such as salt or saltwater, chlorine and other pool chemicals, dyes, and aromatics; an additive dispenser 672 receiving input water and delivering it to a drinking water tap 638, and dispensing drinking water additives such as flavored syrups, nutritional concentrates, alkalizing agents and other balancing agents, aromatics, and compressed carbon dioxide and other gases; an additive dispenser 674 delivering water to a beverage device 632 may dispense any of the above drinking water additives, and further may dispense certain combinations of additives for producing output water with an optimal water profile for making certain beverages, such as coffee.

Some additive dispensers may receive multiple input water streams, such as a cold or tap-temperature stream from a manifold 628 and a hot input water stream from a water heater 622. An additive dispenser 676A-X for a normal water tap 634A-N, such as a sink or bathtub faucet, shower head, or hose spigot, may receive one or both of the “hot” and “cold” streams delivered to the water tap 634A-N in accordance with typical household plumbing. The water system 600 may include X additive dispensers serving N water taps, where, in various embodiments: X may be greater than N, such as when multiple additive dispensers 676A-X may serve a single one of the water taps 634A-N (e.g., a distinct additive dispenser for each of the “hot” and “cold” streams delivered to the water tap); X may be equal to N, such as when each water tap 634A-N has a dedicated additive dispenser 676A-X; or, X may be less than N, such as when some of the water taps 634A-N do not have a connected additive dispenser 676A-X, or when a particular one of the additive dispensers 676A-X serves more than one of the water taps 634A-N. Each of the additive dispensers 676A-X can deliver additives suitable for the point(s)-of-use of the water tap(s) 634A-N that is/are in fluid communication with the dispenser. Non-limiting examples include: high salt concentrations, special salts, aromatics, etc., for a bath; dyes, nutrients, and anti-scalants for a kitchen sink; and, plant fertilizer for a hose spigot. Similarly, an additive dispenser 678 for a dishwasher 636 may deliver salts, detergents, and other dishwashing agents, and an additive dispenser 679 for a washing machine 624 may deliver detergents, fabric softener, etc. In various alternative embodiments of the system 600: a single additive dispenser can be configured to dispense all available additives; a single additive dispenser can service multiple points-of-use or all points-of-use; etc.

The controller 602 may be implemented as a network-enabled device in the home, or may be implemented as part of a cloud-based architecture. For example, in a cloud-based implementation of the controller 602, the functions of the controller 602 may be performed by a dedicated module running on the remote servers 608, which may eliminate the need for a physical controller to be installed in the home or business of the user. In another example, the controller 602 may simply perform data relay functions, receiving data from connected in-home devices and sending the data to the remote servers 608, and/or receiving commands from the remote servers 608 (or the user devices 644 and/or user interface devices 646, 647) and issuing the commands to the connected devices, but otherwise not performing any non-essential data processing. In one embodiment, the controller 602 may be a central control hub, which may include a processor, volatile and non-volatile memory, a user interface, and network interface circuitry. The controller 602 or the remote servers 608 may communicate with the controllers of network-enabled components automatically or in response to manual user commands (e.g., provided at the user interface of the controller 602 or by one of the user devices 644 and/or user interface devices 647).

In some embodiments, such as in the illustrated example, the controller 602 can store or access customization logic 611 comprising machine-readable program instructions that the controller 602 executes to control the additive dispensers of the system 600 and produce customized output water at one or more points-of-use according to system settings or received commands. Additionally or alternatively, the remote servers 608 or the user devices 644/UI devices 646, 647 may store and execute the customization logic 611; any devices executing the customization logic 611 may cooperate to accurately control the appropriate additive dispensers on-demand. In some embodiments, customization logic 611 stored on a user device 644 or a UI device 646, 647 may be embodied in, or may cooperate with, a customization application 645. The customization application 645 may be an installable software program, such as a smartphone “app,” or the customization application 645 may be a web console or web page, or a command line console, or another computer program suitable for displaying a graphical user interface (GUI). The GUI of the customization app 645 may present static and interactive display elements that enable a user of the device 644, 646, 647 to view system data and enter commands that are processed by the controller 602. For example, the GUI may display an arrangement of selectable graphical elements, such as buttons on a touchscreen, that are each associated with a stored water profile as described below; the user's selection of a button can cause the customization application 645 to generate input data identifying the associated water profile as the selected profile, and to send the input data to the controller 602 (or to the remove servers 608, or to the corresponding additive dispenser) for processing.

Thus, program instructions being executed on computing devices including the controller 602, remote servers 608, user devices 644, and/or UI devices 646, 647 cause programming commands to be generated, transmitted, and executed in a process for controlling one or more of the additive dispensers to dispense one or more additives into the corresponding input water to produce output water having desired, custom characteristics. The controller 602, in some embodiments, may store or access a water profile data store 610, which may be an electronic database, lookup table, data file or another suitable data structure that stores relational data for creating output water with the desired characteristics. For example, a water profile may identify the additives to be dispensed into the input water, and the amounts of the additives or flow rates of the dispensation. Additionally, a water profile may include one or more algorithms, such as mathematical formulae, associating the amounts of additives with corresponding characteristics of the input water. For example, water to be delivered to a coffee maker (or to a drinking water tap 638 where the user has selected a “coffee water” profile on the associated UI device 646) can have a desired pH level; the profile may include information for determining, based on the pH of the input water, how much additive (e.g., which may be an acidic compound or a basic compound) to dispense to adjust the pH to the desired level. In other embodiments, the water profile may include parameters and values that describe the additives to be dispensed, and the customization logic 611 may include program instructions for calculating the correct amount of additive to dispense.

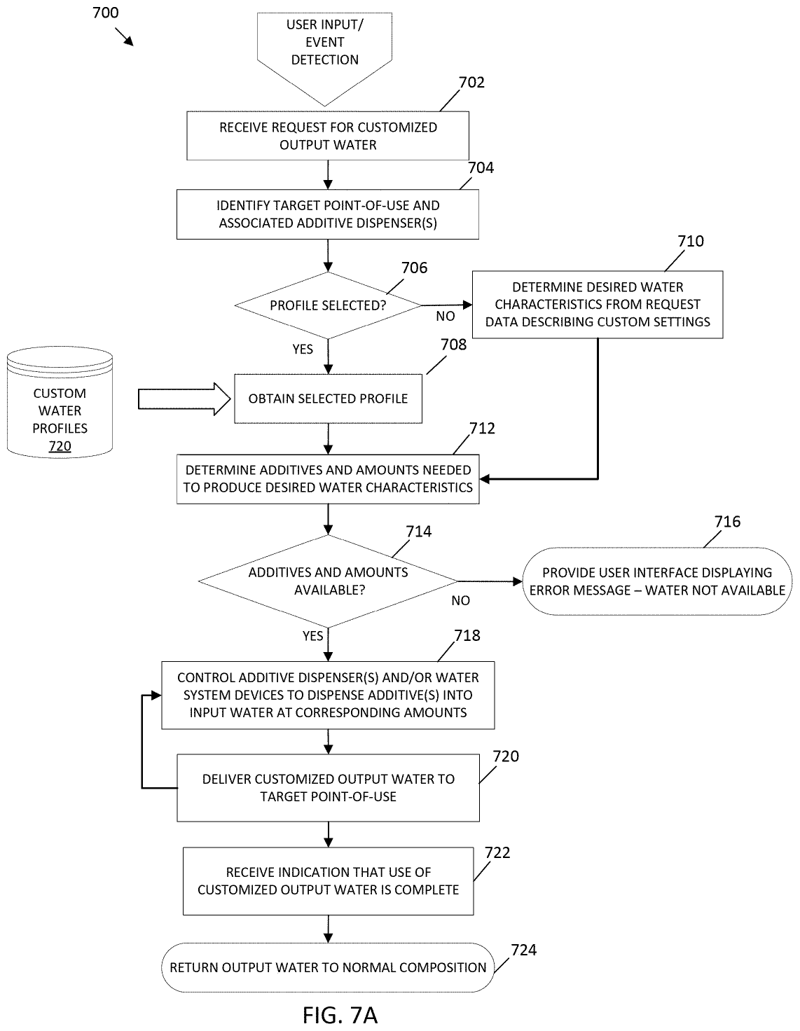

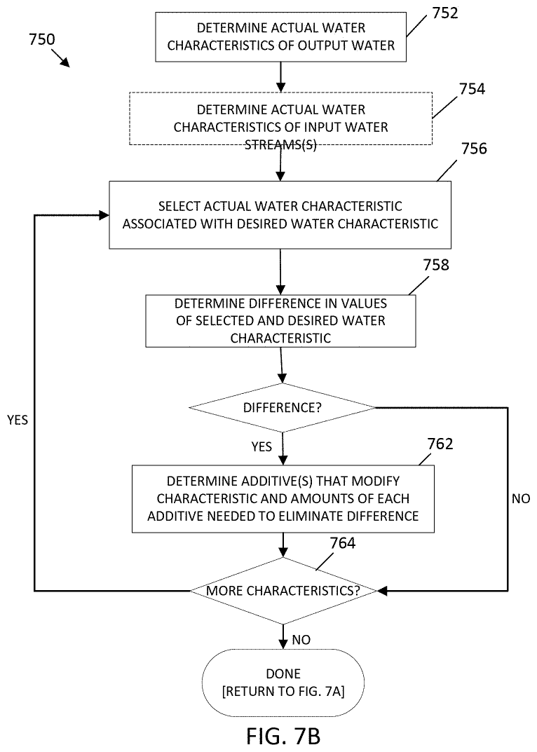

FIG. 7A illustrates an example method 700 executed by a system as described above to generate customized output water at a point-of-use. At 702, the system may receive a request to generate the customized output water. For example, the system may collect user input entered on a user device or a UI device as described above; the user input may include a selection of desired water characteristics and information for identifying the target point-of-use. In another example, a triggering event may cause the system to automatically generate or receive the request according to pre-stored information describing the action to take when the triggering event is detected. Another IoT device (e.g., a device in any of the systems described above with respect to FIG. 5) associated with the residence may cause or detect the triggering event, signaling the system (e.g., by sending an event message describing the triggering event). For example, the user may instruct the system to deliver customized output water for making coffee to a drinking water tap at a certain time in the morning, or in response to a motion detector detecting the user's movement when the user arises in the morning, or in response to an event message from the user's smartphone indicating that the user has accessed the smartphone for the first time of the morning.

At 704, the system can identify, from the request, the target point-of-use and the additive dispenser(s) that should be engaged to service the request. At 706, the system may determine whether the request identifies a water profile selected by the user; if so, at 708 the system may obtain the selected water profile (e.g., from a data store 720 of water profiles). In some embodiments, in addition or alternatively to providing water profiles, the system may enable the user to enter (i.e., via a GUI) desired water characteristics manually). Thus, if no profile is selected, at 710 the system may obtain these manually-entered desired water characteristics from the input data or otherwise based on the request.

With the desired water characteristics identified, at 712 the system may use the desired water characteristics to determine which additives to dispense, and how much of each, by the additive dispenser(s) into the corresponding input water stream(s). An example method of determining the additives and amounts is provided in FIG. 7B. In some embodiments, at 714 the system may determine whether the additives and amounts identified at 712 are available for dispensation. For example, an additive dispenser may be configured to provide status information to a controller of the system, including the amounts available of each additive (e.g., the fluid level in an additive cartridge); the controller may determine whether the amounts needed to satisfy the request are present, based on the status information. If there is an insufficient amount of any of the additives, at 716 the system may reject the request, such as by providing a message for display in the GUI of the user device indicating that additive levels are too low. If there is enough of each required additive, at 718 the system may control the additive dispenser(s) to dispense the additive(s) into the input water. As, or after, the additives are dispensed, at 720 the system may control delivery of the customized output water to the target point-of-use. For example, the system may control a valve at the output port of the additive dispenser, and/or a smart valve occluding the fluid flow at the point-of-use, to open, causing the water blended with the dispensed additive(s) to flow to the point-of-use and be delivered at the customized output water.

At 722, the system may receive an indication that the use of the customized output water is complete. For example, the system may communicate with a flow meter in the fluid path to the target point-of-use to determine that the flow has ceased and has not resumed for a predetermined wait period. At 724, the system may return the output water at the target point-of-use to its normal composition. For example, the system may control the additive dispensers to stop dispensing additives.

FIG. 7B illustrates an example method 750 by which the system determines how much of each additive to dispense into the input water to produce the customized output water having the desired water characteristics (as in 712 of FIG. 7A). At 752 the system may determine the actual water characteristics of the output water that is normally delivered to the target point-of-use. At 754, the system may optionally determine the actual water characteristics of the input water stream(s) received by the additive dispenser(s) being used to generate the customized output water. Real-time water characteristics may be determined using any suitable water composition sensor technology, such as sensors for detecting pH/acidity, TDS, chemical (e.g., fluoride, potassium) content, etc.

In some embodiments, the system may determine the necessary additives and their amounts based on the actual water characteristics of the water being treated as well as the desired water characteristics. At 756 the system may select a characteristic to evaluate from the list of desired water characteristics, and may obtain the associated actual value. For example, “salt content” may be a characteristic that needs a “target” value in the customized output water; the system may thus obtain the salt content of the water being treated. At 758 the system may determine a difference between the actual value and the target value. If there is a difference, at 762 the system determines which additive(s) modif(y)ies the selected water characteristic, as well as the amount of each additive that, when added to the input water, will impart the target value of the selected characteristic upon the customized output water at the target point-of-use. For example, the system can make these determinations by executing one or more algorithms and/or calculating outputs of one or more mathematical formulae that are stored in system memory. At 764, if there are more water characteristics to evaluate, the system may return to 756 and select an unevaluated characteristic, repeating the process until additive(s)/amount(s) have been determined for all desired water characteristics.

Referring to FIG. 8, an example additive dispenser 800 may be disposed in fluid communication between an input water source, such as a feed water source or a manifold, and one or more points-of-use 820. The additive dispenser 800 may in some embodiments operate in the system 600 described above with respect to FIG. 6. The additive dispenser 800 can include a housing 802 with one or more input ports 804A,B and one or more output ports 812. The number of each type of port 804A,B, 812 may depend on the number of input streams 822, 824 and/or the number of output streams 830: in the illustrated example, a first input port 804A may receive a cold water stream 822 and a second input port 804B may receive a hot water stream 824, and the additive dispenser may produce a single, mixed output stream 830 through the output port 812; other designs are contemplated, such as a single input port, or matched pairs of input ports and output ports (e.g., for hot and cold streams that are not mixed inside the housing 802; the additives may be dispensed into either stream or both streams). The housing 802 can define or contain a mixing chamber 808 in which the input water is mixed with additives; in some embodiments where multiple input streams are received, the mixing chamber 808 may further mix the input streams to produce the input water.

A cartridge manifold 850 may be attached to or contained partially or entirely within the housing 802, or can otherwise be in fluid communication with the mixing chamber 808. In some embodiments, a dispenser 852, such as a spigot, tube, or nozzle, or a combination thereof, may connect the cartridge manifold 850 to the mixing chamber 808. The cartridge manifold can retain one or more cartridges 854A,B,C each containing one or more additives. The cartridges 854A-C may be releasable and replaceable, and may be accessed from outside of the housing 802 in some embodiments. The cartridge manifold 850 can include mechanisms for controlling the dispensation of additive from each of the cartridges 854A-C. For example, the cartridge manifold 850 may contain a single mechanized valve for opening and closing all of the cartridges 854A-C at once, or a separate valve for each cartridge 854A-C.

A controller 840 may electrically and/or mechanically connect to the cartridge manifold 850. The controller 840 may be remote from the housing 802, or may be attached to or disposed partially or completely within the housing 802 as shown. The controller 840 can include a microprocessor 842, memory 844 such as memory modules, a transceiver 846 or other communication module(s), and power connections such as an input socket 848 for a power cable and/or an onboard battery 849. Memory 844 can store machine-readable and executable program instructions that the microprocessor 842 executes to exchange data with other components (via the transceiver 846), process the data, and store data in the memory 844. The microprocessor 842 may be configured to send control commands to the cartridge manifold 850 to cause dispensation of specific amounts of one or more of the additives. Alternatively, the controller 840 can include mechanical actuators that connect to the valves of the cartridge manifold 850 and actuate the valves mechanically. The microprocessor 842 can also request and receive status information from the cartridge manifold 850, such as the amount of each additive remaining in each cartridge 854A-C. The microprocessor 842 may also be in electronic communication (via the transceiver 846) with a flow meter 814 that is disposed downstream of the output port 812 and near the point-of-use 820. In some embodiments, the flow meter 814 can report the flow rate of the output stream 830 as it is delivered to the point-of-use as output water 832; the microprocessor 842 can compare the reported flow rate to stored values to control dispensation of the additives. For example, the microprocessor 842 can determine from the flow rate that the faucet at the point-of-use 820 is off, and may prevent additives from dispensing until the water begins flowing. In another example, the memory 844 can store a lookup table or other relational database to determine the amount of each additive to dispense based on the flow rate (i.e., more additive is needed when the water is flowing faster).

A UI device 860 can be connected to, or otherwise disposed in relation to, the point-of-use 820. The UI device 860 can include its own microprocessor 862, memory 864, transceiver 866, and power input 868 as described above. Additionally, for presenting information to a user and receiving user input, the UI device 860 can include various input/output devices 870 such as one or more of: a touchscreen 872; a display 874, such as a LCD screen; one or more speakers 876 or other audio devices; a pointing device 878 such as a mouse or trackball; a keypad and/or keyboard 880, and a microphone 882. The microprocessor 862 can execute stored program instructions in memory to communicate with the controller 840 and to present a user interface 865 to the user. The UI device 860 can be used to activate the customized output water and to select the desired water characteristics. In some embodiments, the memory 864 can store a set of water profiles having a descriptive name and a set of parameters that either or both of the microprocessors 842, 862 translate into values that determine the amounts of each additive to dispense to produce output water 832 with the desired characteristics. The UI 865 may also enable the user to set each of the available parameters manually, to view dispenser status information such as the type(s) of additive(s), the fill level of each cartridge 854A-C, the date each cartridge 854A-C was installed, etc. User inputs can be sent to the microprocessor 842 and translated into control commands for one or both of the microprocessor 842 and the cartridge manifold 850. In alternative embodiments, the UI device 860 may additionally or alternatively communicate directly with the cartridge manifold 850.

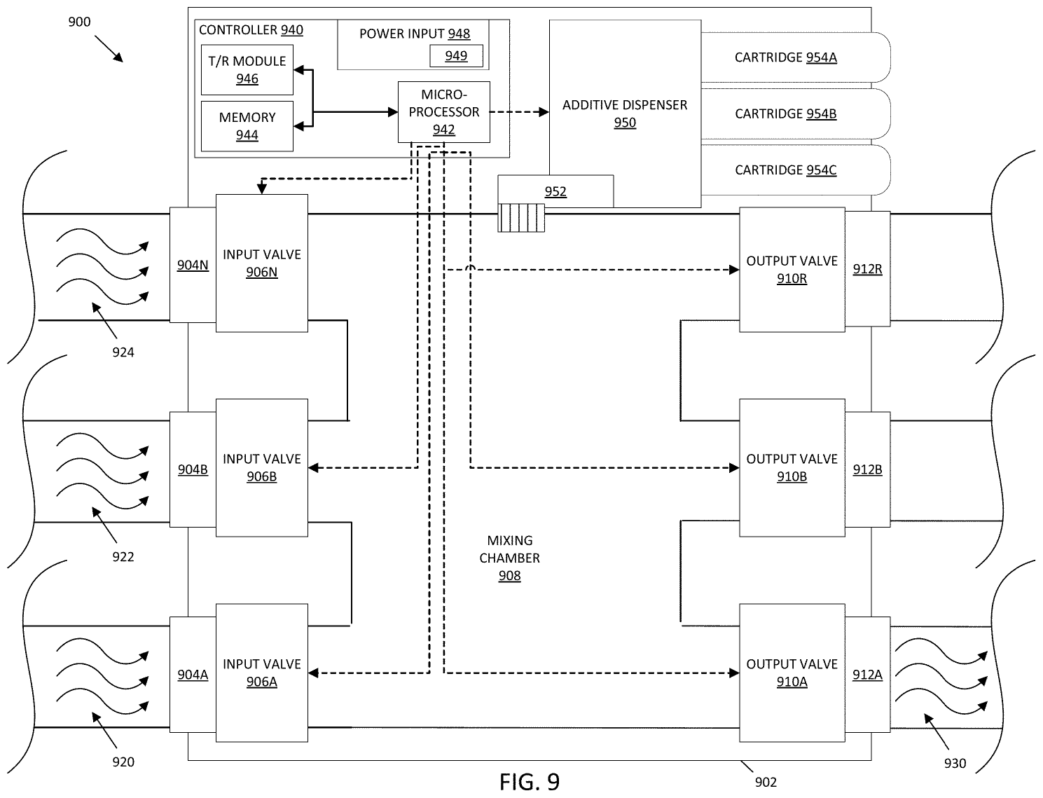

Similarly to FIG. 8, FIG. 9 illustrates an example manifold 900 that can receive input water 920, 922, 924 from multiple sources (i.e., at input ports 906A,B . . . ,N) and deliver customized output water 930 to multiple points-of-use (i.e., through output ports 912A,B, . . . ,R). The manifold 900 can have one or more integrated additive dispensers 950 configured to dispense one or more additives from one or more cartridges 954A,B,C through a spigot 952 into a mixing chamber 908 for mixing with the input water, as described above. A controller 940 including a microprocessor 942, memory 944, a transceiver 946, and one or more power inputs 948, 949 as described above can control the additive dispenser(s) 950 to dispense the appropriate type and amount of additive(s) to impart the desired water characteristics on the output water 930. The controller 940 may electrically and/or mechanically connect to the additive dispenser 950. The manifold 900 can include a housing 902 with one or more input ports input ports 904A-N and one or more output ports 912A-R. The controller 940 may be remote from the housing 902, or may be attached to or disposed partially or completely within the housing 902 as shown. In addition to the functions of the controller 840 of FIG. 8, the controller 940 of the manifold 900 can control input valves 906A,B, . . . ,N each associated with one of the input ports 904A-N to select which of the input streams 920, 922, 924 is received in the mixing chamber 908, and can control output valves 910A,B, . . . ,R each associated with one of the output ports 912A-R to select which of the connected points-of-use will receive the output stream 930.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the systems described may be incorporated into/used in corresponding methods and vice versa.

For the sake of completeness, it is also stated that the term “comprising” does not exclude other elements or steps, the term “a” or “an” does not exclude a plurality, a single processor or other unit may fulfil the functions of several means recited in the claims and any reference signs in the claims shall not be construed as limiting the scope of the claims.

1. A system comprising:
a water system comprising:
a water source;
an additive dispenser coupled to the water source;
a smart valve coupled between and in fluid communication with the water source and the additive dispenser; and
a communication system comprising:
a controller in electronic communication with the additive dispenser, the smart valve, and a communication network, the controller comprising a processor and a memory device configured to store instructions which, when executed, cause the processor to:
receive, from a user device connected to the communication network, a request for customized water at a point-of-use, and
upon receiving the request, control the additive dispenser and the smart valve to modify water received by the additive dispenser from the water source to produce the customized water at the point-of-use.

2. The system of claim 1, wherein the point-of-use comprises a water-using appliance that is selected from the group consisting of: a pool, a spa, a water tap, a beverage device, a dishwasher, a washing machine, and a steam oven.

3. The system of claim 2, wherein the additive dispenser is configured to deliver at least one additive to the water received from the water source to produce the customized water, the at least one additive being selected from the group consisting of: salt, chlorine, an acidic compound, a basic compound, an aromatic compound, a flavoring compound, a mineral compound, dye, nutrients, an anti-scalant compound, plant fertilizer, detergent, and fabric softener.

4. The system of claim 3, wherein the request identifies a custom water profile, and wherein the instructions, when executed, further cause the processor to:
retrieve the custom water profile from a custom water profile data store; and
identify, based on the custom water profile, the at least one additive and at least one amount of the at least one additive to be delivered to the water, wherein the additive dispenser is configured to produce the customized water by delivering the at least one amount of the at least one additive to the water.

5. The system of claim 4, wherein the instructions, when executed, further cause the processor to:
determine that the at least one amount of the at least one additive is not available to the additive dispenser; and
cause an error message to be displayed at a user interface associated with the point-of-use, the error message indicating insufficient additive levels are available to complete the request.

6. The system of claim 3, wherein the request identifies a desired water characteristic, and wherein the instructions, when executed, further cause the processor to:
cause the additive dispenser to deliver an amount of the at least one additive to the water to produce the customized water having the desired water characteristic.

7. The system of claim 6, wherein the instructions, when executed, further cause the processor to:
receive sensor data from at least one sensor in fluid communication with an input of the additive dispenser;
determine, based on the sensor data, an actual water characteristic of the water received by the additive dispenser;
determine a difference between the actual water characteristic to the desired water characteristic; and
determine, based on the difference, the amount of the at least one additive to be added to the water to cause the customized water to have the desired water characteristic.

8. A method comprising:
receiving, by a controller from a user device via an electronic communication network, a request for customized water at a point-of-use, and
upon receiving the request, controlling, by the controller, an additive dispenser and a smart valve coupled between a water source and the additive dispenser to modify water received by the additive dispenser from the water source to produce the customized water at the point-of-use.

9. The method of claim 8, wherein the point-of-use comprises a water-using appliance that is selected from the group consisting of: a pool, a spa, a water tap, a beverage device, a dishwasher, a washing machine, and a steam oven.

10. The method of claim 9, further comprising:
delivering, with the additive dispenser, at least one additive to the water received from the water source to produce the customized water, the at least one additive being selected from the group consisting of: salt, chlorine, an acidic compound, a basic compound, an aromatic compound, a flavoring compound, a mineral compound, dye, nutrients, an anti-scalant compound, plant fertilizer, detergent, and fabric softener.

11. The method of claim 10, wherein the request identifies a custom water profile, and wherein the method further comprises:
retrieving, by the controller, the custom water profile from a custom water profile data store; and
identifying, by the controller based on the custom water profile, the at least one additive and at least one amount of the at least one additive to be delivered to the water, wherein the additive dispenser delivers the at least one amount of the additive to the water to produce the customized water.

12. The method of claim 11, further comprising:
determining, by the controller, that the at least one amount of the at least one additive is not available to the additive dispenser; and
causing, by the controller, an error message to be displayed at a user interface associated with the point-of-use, the error message indicating insufficient additive levels are available to complete the request.

13. The method of claim 10, wherein the request identifies a desired water characteristic, and wherein the method further comprises:
delivering, by the additive dispenser, an amount of the at least one additive to the water to produce the customized water having the desired water characteristic.

14. The method of claim 13, further comprising
receiving, by the controller, sensor data from at least one sensor in fluid communication with an input of the additive dispenser;
determining, by the controller based on the sensor data, an actual water characteristic of the water received by the additive dispenser;
determining, by the controller, a difference between the actual water characteristic to the desired water characteristic; and
determining, by the controller based on the difference, the amount of the at least one additive to be added to the water to cause the customized water to have the desired water characteristic.

15. An additive dispenser comprising:
a mixing chamber comprising:
at least one input port in fluid communication with a water source; and
at least one output port in fluid communication with a point-of-use;
a cartridge manifold in fluid communication with the mixing chamber;
a cartridge coupled to the cartridge manifold and containing an additive, wherein the cartridge manifold is configured to control dispensation of the additive from the cartridge into the mixing chamber; and
a controller communicatively coupled to the cartridge manifold, the controller comprising a transceiver, a processor, and a memory device configured to store instructions which, when executed, cause the processor to:
receive a request for customized water via the transceiver; and
control the cartridge manifold to deliver an amount of the additive contained in the cartridge to the mixing chamber to produce the customized water.

16. The additive dispenser of claim 15, further comprising:
a flow meter disposed at the output of the mixing chamber, communicatively coupled to the controller, and configured to generate flow rate data representing fluid flow rate through the output.

17. The additive dispenser of claim 16, wherein the instructions when executed, further cause the processor to:
periodically receive the flow rate data from the flow meter;
determine that the fluid flow rate through the output is zero based on the flow rate data; and
prevent the cartridge manifold from delivering the additive to the mixing chamber until the flow rate data indicates that fluid is flowing at the output.

18. The additive dispenser of claim 16, wherein the instructions when executed, further cause the processor to:
periodically receive the flow rate data from the flow meter;
perform a comparison of the flow rate data to a look-up table stored in the memory device; and
based on the comparison, determine the amount of the additive to be delivered to the mixing chamber by the cartridge manifold.

19. The additive dispenser of claim 15, further comprising:
a plurality of cartridges, including the cartridge, coupled to the cartridge manifold, wherein each cartridge contains a respective additive of a plurality of additives.

20. The additive dispenser of claim 19, wherein the request identifies a water profile, and wherein the instructions when executed, further cause the processor to:
retrieve the water profile from the memory device;
determine, based on the water profile, amounts of the plurality of additives to be delivered to the mixing chamber to produce the customized water; and
cause the cartridge manifold to deliver the amounts of the plurality of additives to the mixing chamber to produce the customized water.
